(19) United States
(12) Patent Application Publication
(10) Pub. No.: US 2003/0037751 A1
(43) Pub. Date: Feb. 27, 2003

(54) Balancing device for an internal combustion engine

(76) Inventors: Brian Edson Bentley, Truro (CA); James S. Bentley, Beaumont (CA); Marilyn E. Wright, Leduc (CA)

Correspondence Address: MEREK & VOORHEES, 643-B South Washington Street, Alexandria, VA, 22314, US

(21) Appl. No.: 09/938,608

(22) Filed: Aug. 27, 2001

(51) Int. Cl. F02B 75/06

(52) U.S. Cl. 123/192.2

(57) ABSTRACT

An alternator rotor for use in an internal combustion engine having a primary rotated crank shaft. The alternator rotor comprises generally cylindrical rotor housing and a balancing member secured to the rotor housing. The rotor housing is mountable to the crank shaft of the internal combustion engine such that rotation of the crank shaft causes rotation of the rotor housing along an axis of rotation generally parallel to the axis of rotation of the crank shaft. The balancing member includes a moveable mass that is capable of movement generally about the axis of rotation of the rotor housing in response to the rotation of the rotor housing such that upon rotation of the rotor housing the moveable mass moves about the axis of rotation of the rotor housing in response to the both the centrifugal force applied to the moveable mass and to the unbalanced forces generated by rotation of the engine.

### FIELD OF THE INVENTION

This invention relates to balancing devices for use on internal combustion engines, and in particular a new and improved rotor for an alternator that may be used to reduce vibration due to unbalanced forces within the engine.

### BACKGROUND OF THE INVENTION

Internal combustion engines typically derive their power through the ignition and combustion of a fuel and oxygen mixture within a cylinder chamber wherein the expansion of the combustion gases drives a piston that is connected to a primary motor shaft (or crank shaft) by a piston rod. Reciprocation of the piston causes rotation of the motor shaft that may be used to perform work. Internal combustion engines that are used for applications having relatively small or low power requirements may have but a single cylinder and piston driving the motor shaft. More complex engines having increased power outputs typically include a number of separate cylinders, in which case a number of piston rods are attached to the motor shaft providing power thereto. The individual cylinders may be vertically aligned in a row within the engine block, may be in an opposed horizontal configuration, or may be arranged in two opposed and inclined rows, generally referred to as a “V” configuration.

Regardless of the number of cylinders and their particular configuration, operation of the engine and the movement of piston rods and cam shaft results in the generation of vibration that develops through unbalanced forces caused by movement of the various components of the engine. The amount of vibration can be controlled to some extent through the choice of the number of cylinders (often an even number reduces vibration), through the choice of particular cylinder configurations (for example horizontally opposed, in-line, or V), or through the use of vibration reducing structures. While the particular engine layout and design can significantly reduce vibration, vibrational forces cannot be eliminated completely, particularly for all ranges of engine operation. For example, internal combustion engines often develop greater and more significant vibration when idling at lower rpm's and when operating at high rpm's than when running under more typical operating speeds and conditions.

To combat the inherent vibration that tends to develop during the operation of an internal combustion engine, others have developed anti-vibrational devices that may be used in conjunction with the engines. Such devices range from simple anti-vibrational motor mounts (for example rubber, springs, etc.) to move complex weighted structures that may be attached to internal components of the engine in order to reduce unbalanced forces therein. Such devices have generally resulted in a limited degree of success. Anti-vibrational engine mounts do not eliminate vibration but only tend to isolate it from other components to which the engine may be mounted. Similarly, more complex internally positioned structures may assist in reducing unbalanced forces, but often require significant portions of the engine to be dismantled so that they may be connected to the appropriate engine components. In addition, such internal devices also generally tend to be more effective for particular rpm ranges and for the complete operating range of the engine.

### SUMMARY OF THE INVENTION

The invention therefore provides an anti-vibrational or balancing device that may be used in association with an internal combustion engine in order to help reduce vibration of the engine caused through unbalanced forces generated by internal moving parts. The mechanism provides a device that is relatively simple to install and that assists in the reduction of vibration through a wide range of motor operating conditions.

Accordingly, in one of its aspects the invention provides an alternator rotor for use in an internal combustion engine the internal combustion engine having a primary rotated crank shaft, the alternator rotor comprising a generally cylindrical rotor housing, said rotor housing mountable to the crank shaft of the internal combustion engine such that rotation of the crank shaft causes rotation of said rotor housing along an axis of rotation generally parallel to the axis of rotation of the crank shaft; and, a balancing member secured to said rotor housing, said balancing member including a moveable mass that is capable of movement generally about the axis of rotation of said rotor housing in response to the rotation of said rotor housing such that upon rotation of said rotor housing said moveable mass moves about the axis of rotation of said rotor housing in response to the both the centrifugal force applied to said moveable mass and to the unbalanced forces generated by rotation of the engine.

In a further aspect the invention provides a balancing device for reducing vibration due to unbalanced forces created during operation of an internal combustion engine having an alternator that includes a rotor housing that is caused to rotate about a stator through rotation of the shaft of the internal combustion engine, the balancing device comprising an improved rotor housing for receiving over the stator of the alternator, said improved rotor housing generally cylindrical and connected to the shaft of the internal combustion engine such that rotation of the engine shaft causes rotation of said rotor housing, said rotor housing including a sealed chamber mounted generally about the inner or outer circumferential surface of said rotor housing, said sealed chamber at least partially filled with a moveable mass that is free to move within said chamber in response to centrifugal forces applied to said moveable mass through rotation of said motor housing and in response to unbalanced forces generated by the operation of the internal combustion engine.

In yet a further embodiment the invention provides an alternator rotor housing for reducing vibration due to unbalanced forces created by movement of internal parts in an internal combustion engine, the alternator rotor housing including a sealed chamber positioned generally about said rotor housing, said sealed chamber at least partially filled with a moveable mass that is free to move within said chamber in response to the centrifugal forces caused by rotation of the rotor housing and that is free to move within said chamber in response to unbalanced forces created by the operation of the internal combustion engine, such that upon rotation of said rotor housing the centrifugal and unbalanced forces acting upon said moveable mass tend to push said moveable mass to locations within said sealed chamber that result in a reduction of vibration generated by the internal combustion engine.

Further advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a side sectional view through an internal combustion engine having attached thereto a balancing device in the form of an improved alternator rotor in accordance with a preferred embodiment of the present invention;

FIG. 2 is an enlarged side sectional view of the alternator rotor of the internal combustion engine shown in FIG. 1;

FIG. 3 is an interior plan view of the alternator rotor shown in FIG. 2 as viewed from direction A;

FIG. 4 is an external plan view of the alternator rotor shown in FIG. 2 as viewed from direction B;

FIG. 5 is a side sectional view of an alternate embodiment of the alternator rotor shown in FIG. 2;

FIG. 6 is a side sectional view of a further alternate embodiment of the alternator rotor shown in FIG. 1;

FIG. 7 is a side sectional view of a further alternate embodiment of the alternator rotor shown in FIG. 1; and,

FIG. 8 is a side sectional view of yet a further alternate embodiment of the alternator rotor shown in FIG. 1;

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

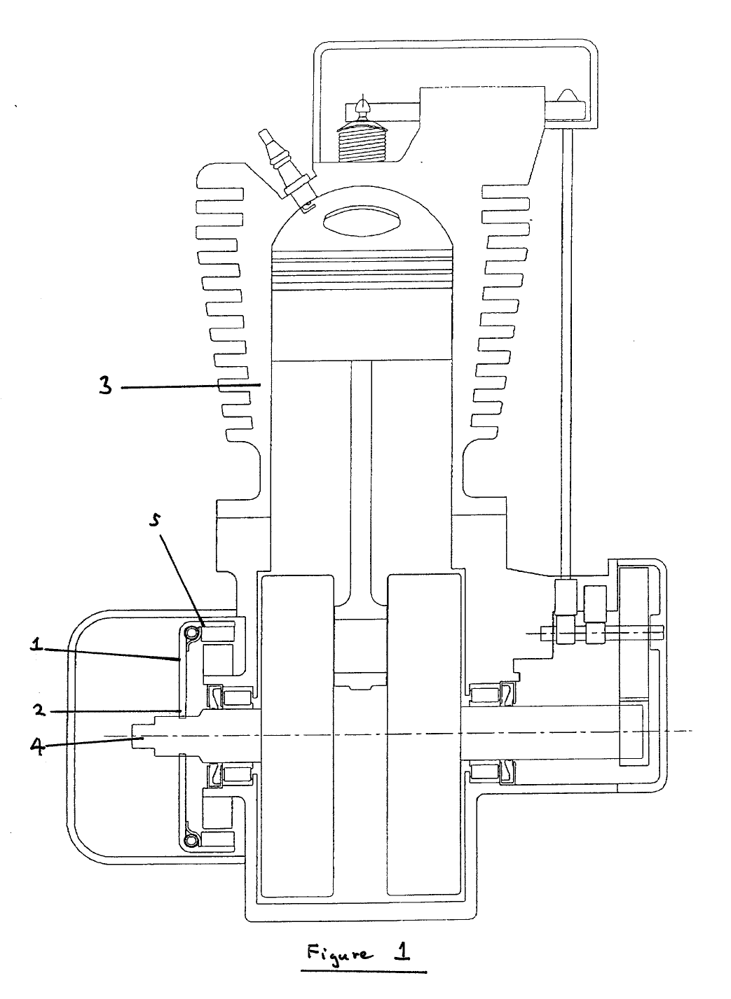

In the enclosed drawings the balancing device in accordance with the present invention is noted generally by reference numeral 1. Balancing device 1 is comprised generally of an alternator rotor 2 for use in association with an internal combustion engine 3, such as that shown in FIG. 1. FIG. 1 illustrates a simplified internal combustion engine having a primary rotated drive shaft or crank shaft 4, a cylinder head 17, a piston 18, and a piston rod 19. Alternator rotor 2 contains all of the typical attributes that are found in a standard alternator rotor. The rotor includes a generally cylindrical rotor housing 5 that is mountable to the drive or crank shaft 4 of internal combustion engine 3, most commonly through receipt over a splined, keyed or tapered portion of the shaft. In these regards, an enclosed end 6 of cylindrical housing 5 is provided with a centrally located bore 7 of a size and configuration to be received over splines (or to receive the keyed or tapered portion) on drive shaft 4 such that rotation of the drive or crank shaft causes a corresponding rotation of cylindrical housing 5. Cylindrical housing 5 also contains about its circumference a series of magnets 16 which rotate with the housing such that the rotation of the magnets about the windings on the alternator's stator has the effect of inducing an electrical current through the stator. To that extent rotor 2 functions much like any other typical rotor used in an alternator.

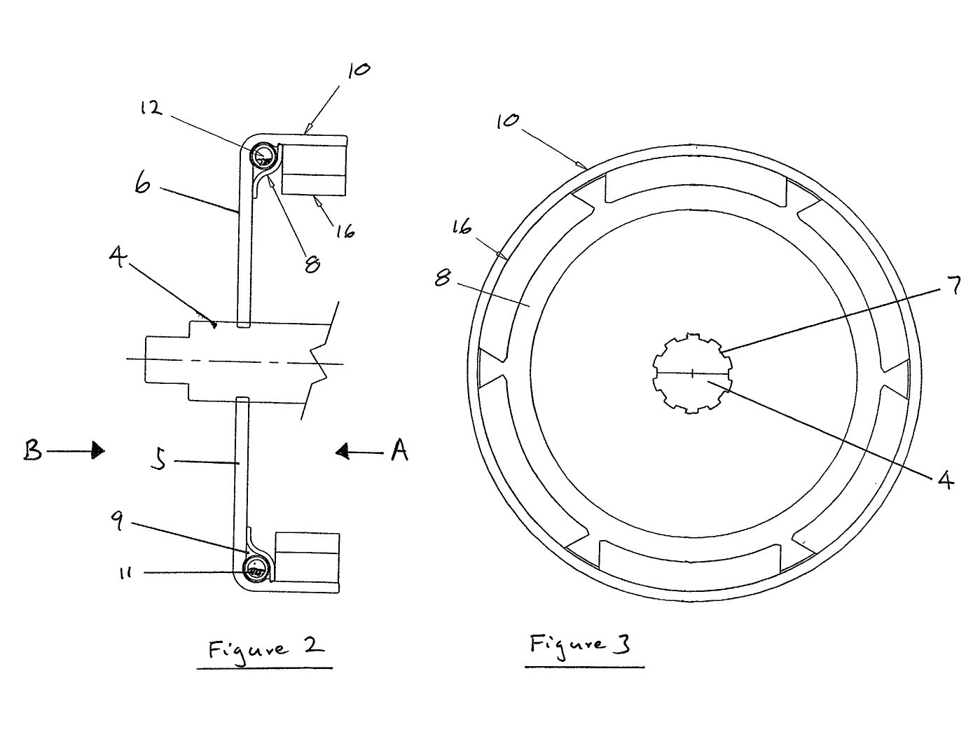

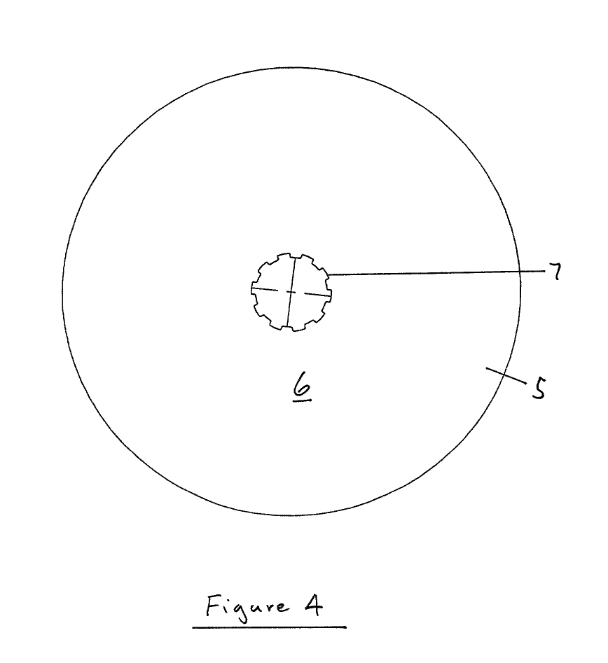

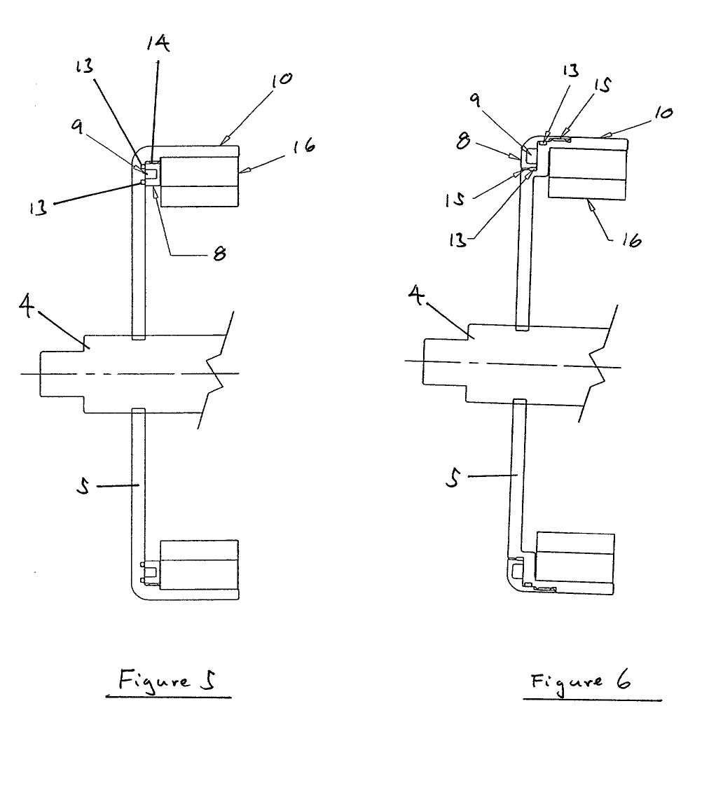

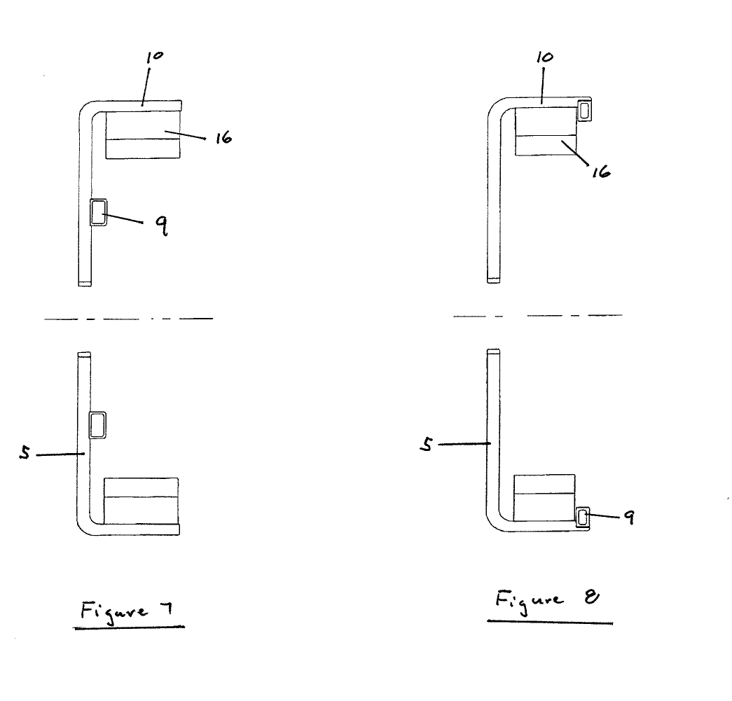

In accordance with the present invention rotor 2 further includes a balancing member 8 secured to cylindrical housing 5. Balancing member 8 includes a chamber 9 situated about housing 5. Typically chamber 9 would be situated about either the inner or outer circumferential surfaces of housing 5, however, it could be positioned elsewhere generally about the axis of rotation of the housing. It will be understood that depending upon the particular configuration of the invention, chamber 9 may be either completely sealed or may be unsealed. Chamber 9 may also be formed integrally with the walls 10 of cylindrical housing 5 (see FIG. 2), may be threadably received within the interior of housing 5 (see threaded connection 14 in FIG. 5), or may be threadably secured and/or glued to the outer surface of housing 5 (see threaded connection 15 in FIG. 6). Alternately, a variety of other fastening mechanisms may be used to secure chamber 9 to cylindrical housing 5 where the chamber is not formed integrally with the housing walls. In such instances, chamber 9 will typically take the form of a generally circular ring that is fastened in some fashion (be it by threading, welding, bolting, screwing, gluing, or otherwise attaching) to cylindrical housing 5. FIGS. 7 and 8 show two alternate embodiments with chamber 9 located in differing positions about housing 5.

Balancing member 8 also includes a moveable mass 11 that is retained within chamber 9 and that is capable of movement generally about the circumference of cylindrical housing 5 in response to the rotation of the housing. That is, upon rotation of housing 5 moveable mass 11 moves through chamber 9 and generally about the circumference of housing 5 in response to both the centrifugal force applied to moveable mass 11, and in response to unbalanced forces generated through rotation of drive or crank shaft 4. Moveable mass 11 may be comprised of a variety of different devices and/or materials. However, in a preferred embodiment of the present invention, moveable mass 11 is comprised of a plurality of high density balls or spheres, a high density liquid, or a combination of a plurality of high density spheres and a high density liquid. Where moveable mass 11 is comprised of or includes high density spheres, the spheres are preferably metallic (for example steel or lead) or a high density plastic or ceramic material. Where moveable mass 11 is comprised of or includes a high density liquid, most preferably the liquid is mercury, or some other similar high density liquid or liquified product. If desired, small amounts of solids may be added to the high density liquid to further increase its density and overall mass.

In order to help facilitate the movement of moveable mass 11 about chamber 9 the chamber preferably has a relatively smooth internal surface and a generally circular cross-sectional area. Where moveable mass 11 includes a liquid, chamber 9 will be sealed and may include an internal circular sealed tubular member 12 within which the liquid is further contained (see FIG. 2). Tube 12 will serve not only to retain the liquid or liquified moveable mass but will also prevent the ingress of dirt and other debris. Where chamber 9 is comprised of a circular ring that is threaded or otherwise attached to cylindrical housing 5, one or more seals 13 maybe utilized in order to prevent leakage of liquid from chamber 9 and/or the ingress of dirt and debris into the chamber (see FIGS. 5 and 6). Where moveable mass 11 is comprised of or includes a plurality of high density spheres, the individual spheres would typically be of a size slightly less than internal cross-sectional area of chamber 9 such that they are small enough to freely move about the chamber, while at the same time large enough to prevent two or more adjacent spheres from becoming jammed within the chamber.

It will be understood by those skilled in the art that the placement of alternator rotor 2 about the drive or crank shaft 4 of internal combustion engine 3 will thus cause moveable mass 11 to rotate about cylindrical housing 5 as cylindrical housing 5 is rotated. Moveable mass 11 will have a tendency of gravitating or pooling at a position within chamber 9 that will result in a reduction of vibration generated by internal combustion engine 3. The combination of the centrifugal force acting upon moveable mass 11 as cylindrical housing 5 is rotated, in conjunction with the unbalanced forces generated by the moving components within the internal combustion engine, generally causes moveable mass 11 to position itself within chamber 9 so as to help balance or offset the unbalanced forces and reduce or minimize vibration within the engine. Since mass 11 is free to move about chamber 9, changes in the unbalanced forces that are developed within internal combustion engine 3 during operation will result in a repositioning of moveable mass 11 within chamber 9, and a continued balancing effect. In this manner balancing device 1 will help to minimize vibration under various speeds and operating conditions of the engine, and under various loading situations.

A brief example of one application of the present invention will now be described with reference to a typical motorcycle engine. Motorcycle engines are often designed to idle at approximately 700 to 1,000 rpm and have an upper operating speed of approximately 5,000 rpm. Such engines often run in an out-of-balance state, causing the characteristic engine vibration or shake that is typically felt when operating many motorcycles. A common motorcycle engine was examined and tested and found to be 57½ grams out of balance at its crank shaft. Thereafter the engine's alternator rotor was removed and replaced with an alternator rotor constructed in accordance with the present invention with its moveable mass 11 comprised of 40 grams of mercury. The engine was then restarted with the new alternator rotor in place. Within approximately one minute the mercury within chamber 9 positioned itself in such a manner so as to essentially balance the engine. The engine remained in a generally balanced state throughout various operating speeds with the moveable mass re-positioning itself within chamber 9 as required to maintain a generally balanced and vibration free engine.

It will, of course, be appreciated the above described invention may equally be used on a wide variety of other types of internal combustion engines. The nature of the invention generally allows it to be easily and quickly adapted and applied to many engines. The device also permits the engine's piston size to be changed, cylinder walls to be bored, and other components altered while allowing for a fast and effective way to re-balance the engine after adjustments or repairs of such a nature have been made. Furthermore, balancing device 1 will help to reduce vibration in an unbalanced engine at a wide range of operating conditions. As the speed of the motor increases or decreases, moveable mass 11 will adjust its position about chamber 9 to accommodate the unbalanced forces, having a retarding effect upon engine vibration. Balancing device 1 will also compensate for engine wear and changes in oil levels and viscosity.

It is to be understood that what has been described are the preferred embodiments of the invention and that it may be possible to make variations to these embodiments while staying within the broad scope of the invention. Some of these variations have been discussed while others will be readily apparent to those skilled in the art.

We claim:

1. An alternator rotor for use in an internal combustion engine the internal combustion engine having a primary rotated crank shaft, the alternator rotor comprising;
(i) a generally cylindrical rotor housing, said rotor housing mountable to the crank shaft of the internal combustion engine such that rotation of the crank shaft causes rotation of said rotor housing along an axis of rotation generally parallel to the axis of rotation of the crank shaft; and,
(ii) a balancing member secured to said rotor housing, said balancing member including a moveable mass that is capable of movement generally about the axis of rotation of said rotor housing in response to the rotation of said rotor housing such that upon rotation of said rotor housing said moveable mass moves about the axis of rotation of said rotor housing in response to the both the centrifugal force applied to said moveable mass and to the unbalanced forces generated by rotation of the engine.

2. The device as claimed in claim 1 wherein said balancing member includes a sealed chamber received generally about the exterior or interior surface of said generally cylindrical rotor housing.

3. The device as claimed in claim 2 wherein said moveable mass is comprised of a plurality of high density spheres.

4. The device as claimed in claim 3 wherein said high density spheres are formed from metal, plastic or a ceramic material.

5. The device as claimed in claim 2 wherein said moveable mass is a high density liquid.

6. The device as claimed in claim 2 wherein said moveable mass is comprised of a plurality of high density spheres and a high density liquid.

7. The device as claimed in claim 6 wherein said high density liquid is mercury.

8. The device as claimed in claim 2 wherein said sealed chamber is formed integrally with the walls of said rotor housing.

9. The device as claimed in claim 2 wherein said sealed chamber is threadably secured to said rotor housing.

10. The device as claimed in claim 2 wherein said rotor housing includes one or more magnets positioned about its circumference such that rotation of said housing causes rotation of said one or more magnets.

11. A balancing device for reducing vibration due to unbalanced forces created during operation of an internal combustion engine having an alternator that includes a rotor housing that is caused to rotate about a stator through rotation of the shaft of the internal combustion engine, the balancing device comprising an improved rotor housing for receiving over the stator of the alternator, said improved rotor housing generally cylindrical and connected to the shaft of the internal combustion engine such that rotation of the engine shaft causes rotation of said rotor housing, said rotor housing including a sealed chamber mounted generally about the inner or outer circumferential surface of said rotor housing, said sealed chamber at least partially filled with a moveable mass that is free to move within said chamber in response to centrifugal forces applied to said moveable mass through rotation of said motor housing and in response to unbalanced forces generated by the operation of the internal combustion engine.

12. The device as claimed in claim 11 wherein said moveable mass is comprised of a plurality of high density spheres.

13. The device as claimed in claim 11 wherein said moveable mass is comprised of a high density liquid.

14. The device as claimed in claim 11 wherein said moveable mass is comprised of a plurality of high density spheres and a high density liquid.

15. An alternator rotor housing for reducing vibration due to unbalanced forces created by movement of internal parts in an internal combustion engine, the alternator rotor housing including a sealed chamber positioned generally about said rotor housing, said sealed chamber at least partially filled with a moveable mass that is free to move within said chamber in response to the centrifugal forces caused by rotation of the rotor housing and that is free to move within said chamber in response to unbalanced forces created by the operation of the internal combustion engine, such that upon rotation of said rotor housing the centrifugal and unbalanced forces acting upon said moveable mass tend to push said moveable mass to locations within said sealed chamber that result in a reduction of vibration generated by the internal combustion engine.

16. The device as claimed in claim 15 wherein said moveable mass is comprised of a plurality of high density spheres.

17. The device as claimed in claim 15 wherein said moveable mass is comprised of a high density liquid.

18. The device as claimed in claim 15 wherein said moveable mass is comprised of a plurality of high density spheres and a high density liquid.
